(19) United States
(12) Patent Application Publication
(10) Pub. No.: US 2019/0050540 A1
(43) Pub. Date: Feb. 14, 2019

(54) JOINT EXAMINATION SYSTEM

(71) Applicant: CORENTEC CO., LTD., Chungcheongnam-do (KR)

(72) Inventors: Oui-Sik Yoo, Seoul (KR); Jae-Hun Ro, Seoul (KR)

(21) Appl. No.: 15/818,189

(22) Filed: Nov. 20, 2017

(30) Foreign Application Priority Data
Aug. 8, 2017 (KR) 10-2017-0100345

(51) Int. Cl. G06F 19/00

(52) U.S. Cl. CPC G06F 19/363; G06F 19/322

(57) ABSTRACT

A joint examination system includes an examination server transmitting request information for performing examination of a joint of a patient to a patient terminal, receiving execution information from the patient terminal in response to the request information, and storing and analyzing the execution information.

### CROSS REFERENCE TO RELATED APPLICATION

The present application claims priority to Korean Patent Application No. 10-2017-0100345, filed Aug. 8, 2017, the entire contents of which is incorporated herein for all purposes by this reference.

### BACKGROUND OF THE INVENTION

### Field of the Invention

The present invention relates generally to a joint examination system. More particularly, the present invention relates to a joint examination system including an examination server transmitting request information for performing examination of a joint of a patient to a patient terminal, receiving execution information from the patient terminal in response to the request information, and storing and analyzing the execution information, whereby patient self-examination and movement examination can be easily performed and efficiency in examination and treatment of the joint of the patient can be enhanced.

### Description of the Related Art

When damage occurs to joints such as a knee joint, a hip joint, a shoulder joint, etc., due to aging, external shock caused by an accident, etc., a patient has joint pain and movement limitations. In order to examine the joint of the patient, measurement data of joint movement is fundamentally required. As shown in FIG. 1, in a conventional joint movement measurement, there are a mechanical measurement device 100, a smart phone 200 with a measurement application, etc. This method is problematic in that there is a large variation in measured data depending on the person who performs measurement, and thus there is a problem in terms of reliability due to inaccuracy.

Also, in addition to the measured joint kinetic data, questions about overall health conditions, painful areas, etc. of the patient and a medical examination obtained through answers of the patient to the questions are required for examination of the damaged joint of the patient. The medical examination is performed through predetermined typical questions as shown in the embodiment of a questionnaire in FIG. 2. It is inconvenient to perform the medical examination at the time of face-to-face medical treatment between the patient and the doctor, thereby reducing efficiency in treatment.

Also, recently, it is common that when a patient having a damaged joint receives a joint implant surgery, long-term hospitalization is avoided to reduce hospital costs, to increase a bed turnover rate, to quickly return to regular life, etc., and rehabilitation is performed at home after short-term hospitalization. However, the patient should receive outpatient treatment for identifying progress and appropriate action during rehabilitation. Compared to hospitalization, it is difficult for the patient to faithfully perform rehabilitation in accurate way, and for the doctor to sufficiently observe the progress of the patient such as change in joint movement thereof, etc.

In the meantime, recently, examination systems enabling a patient to be examined remotely from a medical institution have been introduced. However, conventional examination systems have limitations in examination content as well as on systematic management of the medical record of the patient.

The foregoing is intended merely to aid in the understanding of the background of the present invention, and is not intended to mean that the present invention falls within the purview of the related art that is already known to those skilled in the art.

### DOCUMENT OF RELATED ART

(Patent Document 1) Korean Patent No. 10-1665072 “MEASURING UNIT FOR ANGLE OF JOINT AND MEASURING SYSTEM FOR ANGLE OF JOINT HAVING THE SAME”, Date of Patent: Oct. 5, 2016.

### SUMMARY OF THE INVENTION

Accordingly, the present invention has been made keeping in mind the above problems occurring in the related art.

The present invention is intended to propose a joint examination system including an examination server transmitting request information for performing examination of a joint of a patient to a patient terminal, and receiving execution information from the patient terminal in response to the request information to store and analyze the execution information, thereby enhancing efficiency in examining the joint.

Also, the present invention is intended to propose a joint examination system using the request information including a questionnaire containing a plurality of questions for performing self-examination and the execution information including medical examination information containing answers of the patient to the plurality of questions contained in the questionnaire, thereby enabling the patient to easily perform self-examination without help from medical staff.

Also, the present invention is intended to propose a joint examination system providing a patient-specific questionnaire, thereby enabling the patient to perform self-examination through the patient-specific questionnaire based on the patient medical record, a type of a surgery that a patient has received, a purpose of a study, etc.

Also, the present invention is intended to propose a joint examination system calculating medical examination analysis information containing a quantified or classified emergency level by comparatively analyzing an answer included in the medical examination information to a particular question with regard to an analysis criterion, thereby classifying the patient as being in an emergency or critical condition.

Also, the present invention is intended to propose a joint examination system generating alarm information when the quantified or classified emergency level contained in the medical examination analysis information is in a preset range, thereby enabling the patient in an emergency or critical condition to be promptly treated.

Also, the present invention is intended to propose a joint examination system analyzing a movement of a joint of a patient based on photographed movement information obtained by photographing the patient executing movements, thereby performing effective examination of the joint of the patient.

Also, the present invention is intended to propose a joint examination system quantitatively calculating movement analysis information based on the photographed movement information, thereby performing objective and precise examination on the joint.

Also, the present invention is intended to propose a joint examination system extracting the movement analysis information at a time when the patient feels pain in analyzing the photographed movement information, thereby enhancing efficiency and accuracy in examining the patient.

Also, the present invention is intended to propose a joint examination system enabling an aligned state of an implant transplanted into a patient to be expected based on the photographed movement information.

Also, the present invention is intended to propose a joint examination system using the photographed movement information for examining a joint of a patient such that the use of X-rays, CT/MRI, etc. is reduced, whereby it is economical and exposure to X-rays can be minimized in joint treatment.

Also, the present invention is intended to propose a joint examination system systematically storing and managing through the examination server pre-surgery examination information, post-surgery examination information, and follow-up examination information of a patient who has received a joint implant surgery, thereby ensuring effective patient treatment and rehabilitation.

Also, the present invention is intended to propose a joint examination system including the examination server analyzing examination information of a patient, and systematically storing and managing the examination information, thereby effectively collecting big data for research.

Also, the present invention is intended to propose a joint examination system enabling self-examination or photographing of a patient performing a preset movement through the patient terminal before the patient is treated by a doctor and using the result thereof for treatment, thereby reducing time for medical examination and enhancing efficiency in treatment.

Also, the present invention is intended to propose a joint examination system using an infrared-reflective suit to photograph a patient executing a preset movement through the patient terminal, thereby precisely analyzing the movement of the patient based on photographed movement information.

Also, the present invention is intended to propose a joint examination system enabling self-examination or photographing of a patient performing a preset movement through the patient terminal without help from medical staff, whereby a doctor can effectively perform check-up of a patient at places remote from a hospital.

Also, the present invention is intended to propose a joint examination system enabling examination information provided by the examination server to be effectively and systematically read through a doctor terminal.

Also, the present invention is intended to propose a joint examination system enabling a doctor to easily generate the questionnaire through the doctor terminal, thereby effectively generating a patient-specific questionnaire.

Also, the present invention is intended to propose a joint examination system enabling a doctor to easily generate or modify the analysis criterion through the doctor terminal, thereby promptly classifying the patient as being in an emergency or critical condition.

In order to achieve the above object, the present invention is realized by embodiments having the following configurations.

According to an embodiment of the present invention, a joint examination system includes an examination server transmitting request information for performing examination of a joint of a patient to a patient terminal, receiving execution information from the patient terminal in response to the request information, and storing and analyzing the execution information.

According to another embodiment of the present invention, in the joint examination system, the request information may include a questionnaire containing a plurality of questions for performing self-examination on the joint of the patient, and the execution information may include medical examination information containing answers of the patient to the plurality of questions contained in the questionnaire.

According to still another embodiment of the present invention, in the joint examination system, the examination server may include a questionnaire management part managing a patient-specific questionnaire.

According to still another embodiment of the present invention, in the joint examination system, the questionnaire management part may include: a questionnaire DB storing the patient-specific questionnaire; and a questionnaire search transmission part identifying the patient through patient information transmitted from the patient terminal, and searching the questionnaire DB for the patient-specific questionnaire of the identified patient to transmit the searched patient-specific questionnaire to the patient terminal.

According to still another embodiment of the present invention, in the joint examination system, the questionnaire management part may further include: a preset questionnaire DB storing at least one preset questionnaire for generating the patient-specific questionnaire; and a questionnaire generation part generating the patient-specific questionnaire based on the preset questionnaire stored in the preset questionnaire DB.

According to still another embodiment of the present invention, in the joint examination system, the preset questionnaire may include at least one option that can be added or deleted.

According to still another embodiment of the present invention, in the joint examination system, the questionnaire generation part may generate the patient-specific questionnaire by adding an arbitrary question to the preset questionnaire.

According to still another embodiment of the present invention, in the joint examination system, the examination server may further include a medical examination information analysis part analyzing the medical examination information.

According to still another embodiment of the present invention, in the joint examination system, the medical examination information analysis part may include: an analysis criterion DB storing an analysis criterion for comparatively analyzing an answer included in the medical examination information to a particular question; and a medical examination analysis information calculation part calculating medical examination analysis information containing a quantified or classified emergency level by comparatively analyzing the answer included in the medical examination information to the particular question with regard to the analysis criterion.

According to still another embodiment of the present invention, in the joint examination system, the medical examination information analysis part may further include an alarm information generation part generating alarm information when the quantified or classified emergency level contained in the medical examination analysis information is in a preset range.

According to still another embodiment of the present invention, in the joint examination system, the medical examination information analysis part may further include an analysis criterion generation part generating or modifying the analysis criterion.

According to still another embodiment of the present invention, in the joint examination system, the request information may include execution movement information indicating a preset movement to be executed by the patient, and the execution information may include photographed movement information obtained by photographing the patient executing the preset movement indicated by the execution movement information.

According to still another embodiment of the present invention, in the joint examination system, the examination server may include an execution movement management part managing patient-specific execution movement information.

According to still another embodiment of the present invention, in the joint examination system, the execution movement management part may include: an execution movement DB storing the patient-specific execution movement information; and an execution movement search transmission part identifying the patient through the patient information transmitted from the patient terminal, and searching the execution movement DB for patient-specific execution movement information of the identified patient to transmit the searched patient-specific execution movement information to the patient terminal.

According to still another embodiment of the present invention, in the joint examination system, the examination server may further include a photographed movement information analysis part analyzing the photographed movement information.

According to still another embodiment of the present invention, in the joint examination system, the photographed movement information analysis part may include a movement analysis information calculation part calculating movement analysis information quantitatively indicating a movement of the joint related to the preset movement of the patient by analyzing the photographed movement information.

According to still another embodiment of the present invention, in the joint examination system, the movement analysis information may include a rotation between body segments of the patient that are adjacent to the joint related to the preset movement of the patient.

According to still another embodiment of the present invention, in the joint examination system, movement analysis information may further include a translation between the body segments of the patient that are adjacent to the joint related to the preset movement of the patient.

According to still another embodiment of the present invention, in the joint examination system, the movement analysis information calculation part may include: a body segment recognition part recognizing the body segments adjacent to the joint related to the preset movement of the patient indicated in the photographed movement information; and a movement analysis information arithmetic part setting at least three landmarks for each of the recognized body segments, setting a segment coordinate system, which defines a movement of each of the recognized body segments, for each of frames of the photographed movement information based on the landmarks of each of the recognized body segments, and calculating the movement analysis information as a numerical value indicating a relative movement between the recognized body segments.

According to still another embodiment of the present invention, in the joint examination system, the photographed movement information may further include pain frame identification information identifying a frame obtained at a time when the patient feels pain among the frames, and the movement analysis information calculation part further includes a pain time movement analysis information extraction part extracting pain time movement analysis information that means the movement analysis information at the time when the patient feels pain while executing the preset movement based on the pain frame identification information and the movement analysis information.

According to still another embodiment of the present invention, in the joint examination system, the photographed movement information analysis part may further include an implant alignment prediction part predicting an alignment state of an implant transplanted into the joint related to the preset movement of the patient based on the movement analysis information.

According to still another embodiment of the present invention, in the joint examination system, the implant alignment prediction part may include: an implant alignment information DB storing an implant alignment parameter indicating an alignment position of the implant transplanted into the joint of the patient and several pieces of kinematic data quantitatively indicating the movement of the joint into which the implant is transplanted; and an implant alignment parameter arithmetic part deriving the implant alignment parameter of the patient by comparatively analyzing the movement analysis information calculated by the movement analysis information calculation part and the kinematic data of the implant alignment information DB.

According to still another embodiment of the present invention, in the joint examination system, the implant alignment prediction part may further include an implant alignment image generation part generating an implant alignment image, which is a prediction alignment image of the implant transplanted into the joint of the patient, based on the implant alignment parameter derived by the implant alignment parameter arithmetic part.

According to still another embodiment of the present invention, in the joint examination system, the examination server may further include an examination information management part managing patient-specific examination information containing at least one of the medical examination information, the photographed movement information, the medical examination analysis information, the movement analysis information, the pain time movement analysis information, the implant alignment parameter, and the implant alignment image.

According to still another embodiment of the present invention, in the joint examination system, the examination information management part may include an examination information DB storing the patient-specific examination information.

According to still another embodiment of the present invention, in the joint examination system, the examination information may be divided into pre-surgery examination information, post-surgery examination information, and follow-up examination information in a case of an implant-transplanted patient.

According to still another embodiment of the present invention, in the joint examination system, the examination information management part may further include an examination information collection part updating the examination information DB when at least one of the medical examination information and the photographed movement information is newly received or when at least one of the medical examination analysis information, the alarm information, the movement analysis information, the pain time movement analysis information, the implant alignment parameter, and the implant alignment image is newly generated.

According to still another embodiment of the present invention, in the joint examination system, the examination information management part may further include an examination information provision part providing updated examination information to a doctor terminal when the examination information DB has the updated examination information.

According to still another embodiment of the present invention, in the joint examination system, the examination information provision part may immediately provide the updated examination information to the doctor terminal when the updated examination information contains the alarm information.

According to still another embodiment of the present invention, the joint examination system may further include the patient terminal transmitting the patient information containing patient identification information to the examination server, receiving the request information from the examination server, and generating the execution information in response to the request information to transmit the execution information to the examination server.

According to still another embodiment of the present invention, in the joint examination system, the patient terminal may include a patient information transmission part receiving the patient information and transmitting the patient information to the examination server.

According to still another embodiment of the present invention, in the joint examination system, the patient terminal may further include a medical examination execution part receiving the questionnaire to provide the questionnaire to the patient, and generating the medical examination information by receiving the answers to the questionnaire so as to transmit the medical examination information to the examination server.

According to still another embodiment of the present invention, in the joint examination system, the patient terminal may further include a movement examination execution part receiving the execution movement information to provide the execution movement information to the patient, and generating the photographed movement information by photographing the patient executing the preset movement indicated by the execution movement information so as to transmit the photographed movement information to the examination server.

According to still another embodiment of the present invention, in the joint examination system, the movement examination execution part may include: a movement execution request part receiving the execution movement information and requesting the patient to execute the preset movement of the execution movement information; and a movement execution photographing part generating the photographed movement information by photographing the patient executing the preset movement.

According to still another embodiment of the present invention, in the joint examination system, the movement execution photographing part may photograph the patient executing the preset movement through infrared detection.

According to still another embodiment of the present invention, the joint examination system may further include an infrared-reflective suit that the patient wears when being photographed by the movement execution photographing part.

According to still another embodiment of the present invention, in the joint examination system, the infrared-reflective suit may be coated with an infrared-reflective material on a surface thereof.

According to still another embodiment of the present invention, in the joint examination system, the infrared-reflective suit may contain markings for indicating the landmarks of each of the recognized body segments of the patient.

According to still another embodiment of the present invention, in the joint examination system, the movement examination execution part may further include: a movement stop recognition part recognizing movement stop when the preset movement of the patient is stopped over a preset period of time while the movement execution photographing part photographs the patient executing the preset movement; and a pain verification part adding the pain frame identification information identifying the frame obtained at the time when the patient feels pain, to the photographed movement information when the movement stop recognition part recognizes the movement stop and pain is verified by the patient.

According to still another embodiment of the present invention, the joint examination system may further include the doctor terminal receiving the examination information from the examination server.

According to still another embodiment of the present invention, in the joint examination system, the doctor terminal may further include an examination information reception display part receiving the examination information and displaying the examination information.

According to still another embodiment of the present invention, in the joint examination system, the examination information reception display part may preferentially display the examination information containing the alarm information, and may display other examination information in a descending order of the quantified or classified emergency level included in the medical examination analysis information.

According to still another embodiment of the present invention, in the joint examination system, the doctor terminal may further include a questionnaire generation information provision part providing questionnaire generation information for generating the questionnaire to the questionnaire generation part.

According to still another embodiment of the present invention, in the joint examination system, the doctor terminal may further include an analysis criterion generation information provision part providing analysis criterion generation information for generating or modifying the analysis criterion to the analysis criterion generation part.

The present invention may have the following effects from the embodiments, construction, combination, and element coupling relationship that will be described later herein.

The preset invention provides an examination server transmitting request information for performing examination of a joint of a patient to a patient terminal, and receiving execution information from the patient terminal in response to the request information to store and analyze the execution information, whereby efficiency in examining the joint can be enhanced.

According to the present invention, the request information includes a questionnaire containing a plurality of questions for performing self-examination, and the execution information includes medical examination information containing answers of the patient to the plurality of questions contained in the questionnaire, whereby the patient can easily perform self-examination without help from medical staff.

The present invention provides a patient-specific questionnaire, whereby self-examination can be performed through the patient-specific questionnaire based on the patient medical record, a type of a surgery that a patient has received, a purpose of a study, etc.

The present invention can calculate medical examination analysis information containing a quantified or classified emergency level by comparatively analyzing an answer included in the medical examination information to a particular question with regard to an analysis criterion, whereby the patient in an emergency or critical condition can be classified.

The present invention can generate alarm information when the quantified or classified emergency level contained in the medical examination analysis information is in a preset range, whereby the patient in an emergency or critical condition can be promptly treated.

The present invention can analyze a movement of a joint of a patient based on photographed movement information obtained by photographing the patient executing, whereby effective examination can be performed on the joint of the patient.

The present invention can quantitatively calculate movement analysis information based on the photographed movement information, whereby objective and precise examination can be performed on the joint.

The present invention can extract the movement analysis information at a time when the patient feels pain in analyzing the photographed movement information, whereby efficiency and accuracy in examining the patient can be enhanced.

The preset invention can predict an aligned state of an implant transplanted into a patient based on the photographed movement information.

The present invention can reduce the use of X-rays, CT/MRI, etc. by using the photographed movement information for examining a joint of a patient, whereby it is economical and exposure to X-rays can be minimized in joint treatment.

The present invention can systematically store and manage through the examination server pre-surgery examination information, post-surgery examination information, and follow-up examination information of a patient who has received a joint implant surgery, whereby effective patient treatment and rehabilitation can be ensured.

The present invention can provide the examination server analyzing examination information of a patient, and can systematically store and manage the examination information, whereby big data for research can be effectively collected.

The present invention enables self-examination or can photographing of a patient performing a preset movement through the patient terminal before the patient is treated by a doctor and can use the result thereof for treatment, whereby time for medical examination can be reduced and efficiency in treatment can be enhanced.

The present invention provides an infrared-reflective suit to photograph a patient executing a preset movement through the patient terminal, whereby the movement of the patient based on photographed movement information can be precisely analyzed.

The present invention enables self-examination or can photograph a patient performing a preset movement through the patient terminal without help from medical staff, whereby a doctor can effectively perform check-up of a patient at places remote from a hospital.

The present invention enables examination information provided by the examination server to be effectively and systematically read through a doctor terminal.

The present invention enables a doctor to easily generate the questionnaire through the doctor terminal, whereby a patient-specific questionnaire can be effectively generated.

The present invention enables a doctor to easily generate or modify the analysis criterion through the doctor terminal, whereby the patient in an emergency or critical condition can be promptly classified.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view illustrating conventional joint movement measurement;

FIG. 2 is a view illustrating an example of a questionnaire used in conventional medical examination;

FIG. 3 is a configuration diagram illustrating a joint examination system according to an embodiment of the present invention;

FIG. 4 is a configuration diagram illustrating a patient terminal;

FIG. 5 is a configuration diagram illustrating a patient information transmission part of the patient terminal;

FIG. 6 is a configuration diagram illustrating a medical examination execution part of the patient terminal;

FIG. 7 is a configuration diagram illustrating a movement examination execution part of the patient terminal;

FIG. 8 is a view illustrating an infrared-reflective suit of a joint examination system according to an embodiment of the present invention;

FIG. 9 is a configuration diagram illustrating an examination server of a joint examination system according to an embodiment of the present invention;

FIG. 10 is a configuration diagram illustrating a questionnaire management part of the examination server;

FIG. 11 is a configuration diagram illustrating a medical examination information management part of the examination server;

FIG. 12 is a configuration diagram illustrating a medical examination information analysis part of the examination server;

FIG. 13 is a configuration diagram illustrating an execution movement management part of the examination server;

FIG. 14 is a configuration diagram illustrating a photographed movement information management part of the examination server;

FIG. 15 is a configuration diagram illustrating a photographed movement information analysis part of the examination server;

FIG. 16 is a configuration diagram illustrating a movement analysis information calculation part of the photographed movement information analysis part;

FIG. 17 is a view illustrating a detailed embodiment of calculating movement analysis information by the movement analysis information calculation part;

FIG. 18 is a view illustrating a detailed embodiment of the movement analysis information calculated by the movement analysis information calculation part;

FIG. 19 is a configuration diagram illustrating an implant alignment prediction part of the photographed movement information analysis part;

FIG. 20 is a table of data extracted for particular points of the movement analysis information related to the movement of the knee joint of the patient;

FIGS. 21A to 21D are views illustrating a process of deriving an implant alignment parameter by the implant alignment parameter arithmetic part based on the data extracted as shown in FIG. 20;

FIG. 22 is view of the implant alignment parameter arithmetic part repeatedly performing the process shown in FIGS. 21A to 21D for the remaining data in the table of FIG. 20;

FIG. 23 is a view illustrating a detailed embodiment of an implant alignment prediction image generated by the implant alignment prediction part;

FIG. 24 is a configuration diagram illustrating an examination information management part of the examination server;

FIG. 25 is a configuration diagram illustrating a joint examination system according to another embodiment of the present invention; and

FIG. 26 is a configuration diagram illustrating a doctor terminal.

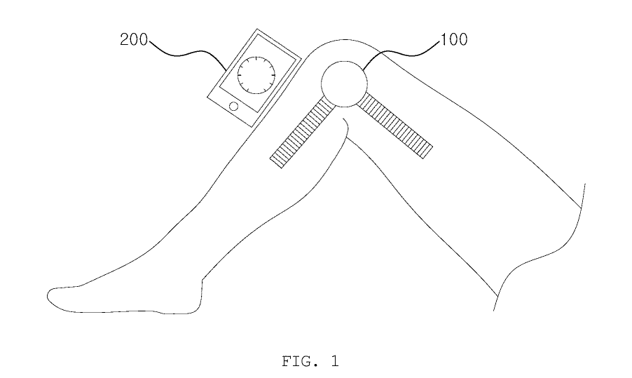

### DETAILED DESCRIPTION OF THE INVENTION

Hereinbelow, a joint examination system according to the present invention will be described in detail with reference to the accompanying drawings. Unless otherwise defined, all terms including technical and scientific terms used herein have the same meaning as commonly understood by one of ordinary skill in the art to which this invention belongs. When terms used herein differ from the commonly understood meaning, the terms will be interpreted as defined herein. Also, detailed descriptions of known functions and components incorporated herein will be omitted when it may make the subject matter of the present invention unclear.

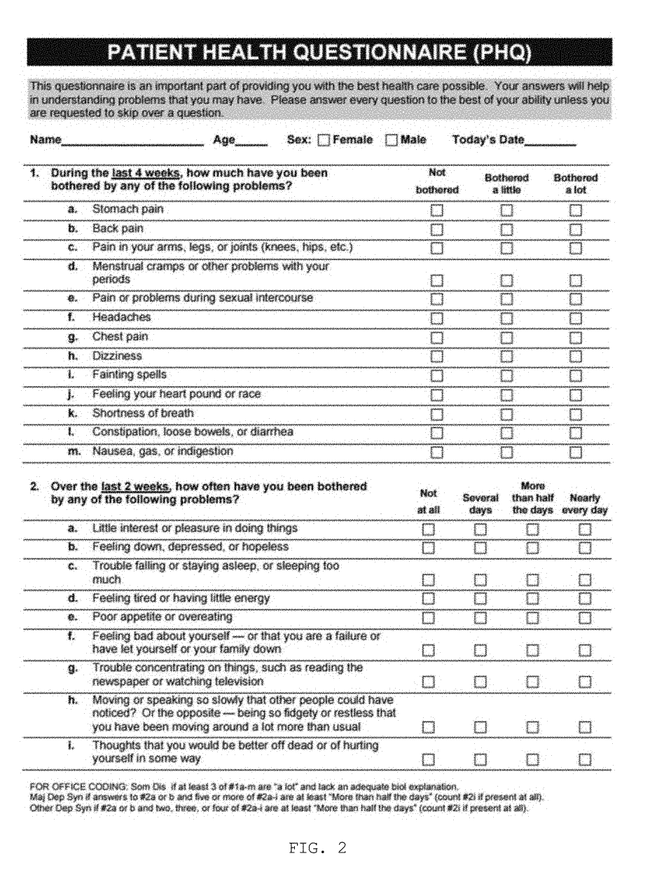

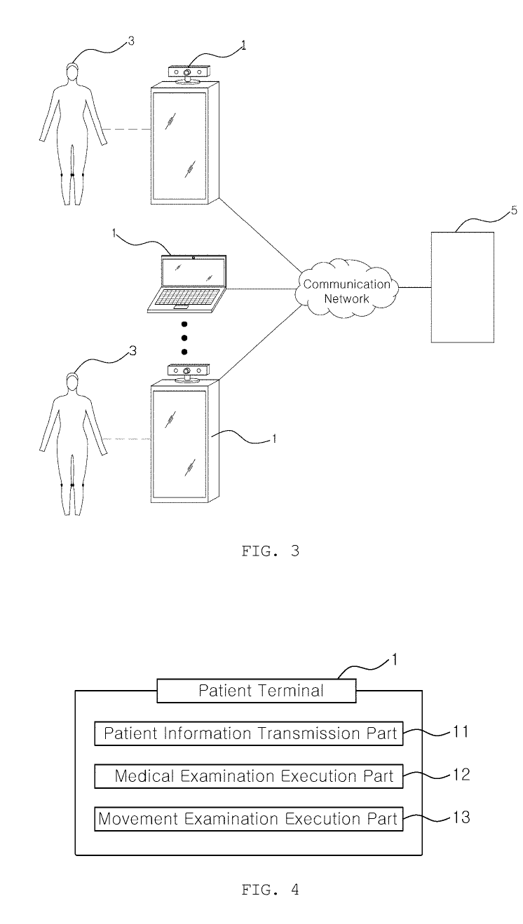

FIG. 3 is a configuration diagram illustrating a joint examination system according to an embodiment of the present invention. Referring to FIG. 3, the joint examination system according to the embodiment of the present invention may include a patient terminal 1, an infrared-reflective suit 3, and an examination server 5.

The patient terminal 1 transmits patient information containing patient identification information to the examination server 5, receives request information from the examination server 5, and generates execution information in response to the request information to transmit the execution information to the examination server 5. The request information may include at least one of a questionnaire for performing self-examination by a patient and execution movement information for performing movement examination. The execution information may include at least one of medical examination information containing answers of the patient to the questionnaire and photographed movement information obtained by photographing the patient executing a preset movement indicated by the execution movement information.

FIG. 4 is a configuration diagram illustrating the patient terminal 1 of the joint examination system according to the embodiment of the present invention. Referring to FIG. 4, the patient terminal 1 may include a patient information transmission part 11, a medical examination execution part 12, and a movement examination execution part 13.

The patient terminal 1 may be installed in medical institutions such as hospitals as well as distant places from the hospital such as patient's home, etc. As shown in FIG. 3, several patient terminals 1 may be used, and each of several patient terminals 1 transmits execution information to the examination server 5, whereby the examination server 5 can receive execution information from several patients at different places, and can store, analyze, and manage the execution information. Also, the patient terminal 1 enables the patient to perform self-examination without help from medical staff, thereby enhancing efficiency and convenience in examining a joint of a patient.

The patient terminal 1 may be realized as a mobile terminal, i.e., a smart phone, a tablet PC, etc., a PC, a smart TV, a smart mirror, etc. When the patient terminal 1 is installed in patient's home, it is economical to realize the patient terminal 1 through a mobile terminal, a PC, a smart TV, etc. of the patient. When the patient terminal 1 is installed in a hospital, it is effective to realize the patient terminal 1 as a smart mirror for examination only.

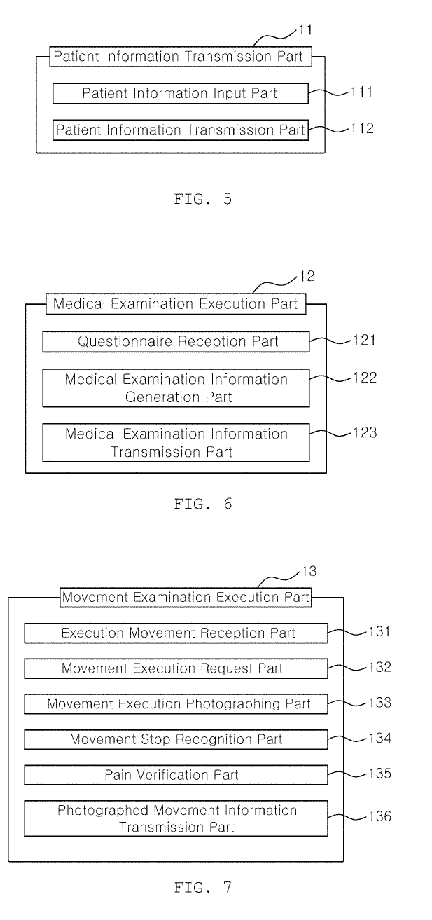

The patient information transmission part 11 receives the patient information containing the patient identification information through the patient terminal 1, and transmits the patient information to the examination server 5. Referring to a configuration diagram of the patient information transmission part 11 in FIG. 5, the patient information transmission part 11 may include a patient information input part 111 and a patient information transmission part 112.

The patient information input part 111 receives the patient information. The patient information input part 111 may be realized as a touch screen, a monitor and keyboard, a voice input part, etc. The patient information includes the identification information for identifying a patient, and the identification information may be a social security number of a patient, a medical number issued by a particular medical institution, etc. The patient information may include the identification information as well as information of at least one of patient's name, gender, age, height, and weight. Also, the patient information may include symptom information about patient's painful areas, pain levels, etc. Also, the patient information may include identification information of a medical institution where the patient is treated. The patient information input part 111 may display painful areas or pain levels in a manner of being selected from options for input of the symptom information. In this case, the symptom information may be input in a manner of selecting a particular option.

In the meantime, when the joint examination system of the present invention is open to members only, the identification information of the patient information received by the patient information input part 111 may include an ID, a password, etc. for log-in. Also, after transmission of the patient information by the patient information transmission part 112 and authentication by the examination server 5, examination may be performed through the patient terminal 1.

The patient information transmission part 112 transmits the patient information that is input through the patient information input part 111, to the examination server 5. The patient information transmission part 112 is connected to the examination server 5 via a wired/wireless communication network to perform communication, and transmits the patient information. The patient information transmitted by the patient information transmission part 112 is received by the examination server 5.

When the patient information transmission part 112 transmits the patient information to the examination server 5, the examination server 5 transmits the request information including at least one of a questionnaire and execution movement information that are appropriate for the condition or situation of the patient. Accordingly, the patient can perform self-examination, self-movement examination, etc.

The medical examination execution part 12 receives the questionnaire related to examination of the patient from the examination server 5 to provide the questionnaire to the patient, receives answers to the questionnaire to generate medical examination information, and transmit the generated medical examination information to the examination server 5. As shown in a configuration diagram of the medical examination execution part 12 in FIG. 6, the medical examination execution part 12 may include a questionnaire reception part 121, a medical examination information generation part 122, and a medical examination information transmission part 123.

The questionnaire reception part 121 receives the questionnaire for medical examination from the examination server 5. As described above, when the patient information transmission part 11 transmits the patient information to the examination server 5, the examination server 5 transmits the questionnaire for medical examination of the patient. The questionnaire includes a plurality of questions for self-examination of a joint of the patient. The questionnaire may be provided in one preset form, but may be provided in different forms according to symptoms, painful parts, types of performed surgery, gender, age, etc. of the patient. Specifically, the examination server 5 receives the patient information, and transmits a patient-specific questionnaire to the patient terminal 1 based on the identification information contained in the patient information, whereby effective self-examination of the patient can be performed.

The medical examination information generation part 122 provides the questionnaire received by the questionnaire reception part 121 to the patient, and generates the medical examination information by receiving answers of the patient to the questionnaire. That is, the medical examination information means information containing answers of the patient to the questions of the questionnaire. The medical examination information generation part 122 provides the questionnaire received from the examination server 5 to the patient, and receives answers of the patient to the questionnaire. The medical examination information generation part 122 may include at least one of a touch screen, a monitor and keyboard, and a voice input part. The questionnaire may be provided in a manner of a display, guide voice, etc. Input of answers of the patient to the questionnaire may be performed in at least one manner of a touch screen, a keyboard, and voice.

When answers of the patient to the questions of the questionnaire are input and the medical examination information is generated in consequence thereof, namely, when the medical examination information is generated by the medical examination information generation part 122, the medical examination information transmission part 123 transmits the generated medical examination information to the examination server 5. The medical examination information transmitted to the examination server 5 is stored and analyzed by the examination server 5 such that the medical examination information may be utilized as fundamental reference data when a doctor treats a patient in a medical institution. According to the present invention, a patient can perform self-examination through the patient terminal 1 in advance, whereby perfunctory medical examination can be omitted, and thus shortening the time for treatment and enhancing efficiency in treatment.

The movement examination execution part 13 generates photographed movement information by photographing the patient executing the preset movement, and transmits the photographed movement information to the examination server 5. As shown in a configuration diagram of the movement examination execution part 13 in FIG. 7, the movement examination execution part 13 may include an execution movement reception part 131, a movement execution request part 132, a movement execution photographing part 133, a movement stop recognition part 134, a pain verification part 135, and a photographed movement information transmission part 136.

The execution movement reception part 131 receives the execution movement information transmitted from the examination server 5 for movement examination of the patient. The movement examination means that the patient executes the preset movement to perform examination to check the condition of the joint of the patient, and the execution movement information means information indicating the preset movement to be executed by the patient for the movement examination. The execution movement information may include at least one of visual and auditory information informing the patient of the preset movement to be performed. In order to easily make the patient understand, it is desirable that the execution movement information includes a demonstration video of the preset movement to be performed by the patient. The examination server 5 receives the patient information transmitted by the patient information transmission part 112, and transmits the execution movement information to the patient terminal 1 based on the patient information. The execution movement reception part 131 receives the execution movement information.

In the meantime, the examination server 5 may provide the execution movement information appropriate to the patient based on the identification information in the patient information. That is, the execution movement reception part 131 receives patient-specific or symptom-specific execution movement information from the examination server 5. For example, for the patient having pain in the knee joint, a lunge movement or squat movement may be indicated by the execution movement information, and for the patient having pain in the shoulder joint, an arm twisting movement may be indicated by the execution movement information.

The movement execution request part 132 requests the patient to execute a particular movement. The movement execution request part 132 provides the execution movement information received by the execution movement reception part 131 from the examination server 5, to the patient. The movement execution request part 132 may be realized by including at least one of a display device, i.e., a touch screen, a monitor device, etc., and a voice output device, i.e., a speaker, etc. It is desirable to provide an interface visually presenting the preset movement contained in the execution movement information such that the patient can immediately understand the execution movement information and can precisely execute a particular movement indicated by the execution movement information.

In the meantime, it is desirable that the movement execution request part 132 requests the patient to take a particular static posture in addition to the preset movement indicated by the execution movement information. A movement analysis information calculation part 561 of the examination server 5 may use, as reference information, the length of the body segment of the patient in the particular static posture such as a stating posture measured in the process of calculating the movement analysis information. Therefore, the movement execution request part 132 may request the patient to take the particular static posture such as standing at attention before or after that the patient executes the preset movement according to the execution movement information. Accordingly, the movement execution photographing part 133 may photograph the patient having the particular static posture.

The movement execution photographing part 133 generates the photographed movement information by photographing the patient executing the preset movement. The movement execution photographing part 133 may photograph the patient executing the preset movement or having the particular static posture in response to the request of the movement execution request part 132. The movement execution photographing part 133 photographs the patient executing the preset movement through infrared detection. Specifically, the movement execution photographing part 133 may be realized as a Kinect technology-based RGB camera, an infrared camera, etc used in measuring vital movements.

It is desirable that the movement execution photographing part 133 includes a monitoring display, i.e., a mirror display, etc., such that the patient executing the preset movement according to the execution movement information can see himself/herself. Through this, the patient corrects own movement in real-time, thereby obtaining photographed movement information for precisely and easily calculating the movement analysis information.

In the meantime, as described above, information obtained by photographing the patient having the particular static posture may be required in the process of calculating the movement analysis information. Thus, it is desirable that the movement execution photographing part 133 photographs the patient having the particular static posture and the photographed movement information includes the information obtained by photographing the patient having the particular static posture.

While the movement execution photographing part 133 photographs the patient executing the preset movement, when the movement of the patient is stopped over a preset period of time, the movement stop recognition part 134 recognizes the movement stop. That is, the movement stop recognition part 134 recognizes that the patient stops executing the preset movement while the movement execution photographing part 133 photographs the patient executing the preset movement. Generally, according to the alignment position of implants for the patient with implants and to the damaged part of the joint of the patient without implants, the point where pain is felt during execution of the preset movement differs. When the patient feels pain, the patient stops movement. Therefore, when the patient stops executing the preset movement, it is most likely due to pain. Based on such the fact, the movement stop recognition part 134 enables the patient to verify pain by recognizing movement stop during execution of the preset movement of the patient.

When the movement stop recognition part 134 recognizes the stopping of movement, and when pain is verified by the patient, the pain verification part 135 adds pain frame identification information to the photographed movement information, the pain frame identification information identifying a fame obtained at a time when the patient feel pain. The photographed movement information of the patient photographed by the movement execution photographing part 133 is composed of several frames. For example, when the patient stops the preset movement at a time of the 1300th frame while the movement execution photographing part 133 generates the photographed movement information, and it is verified that the patient stops moving due to pain, the pain verification part 135 designates the 1300th frame of the photographed movement information as a pain frame to add the pain frame identification information.

The pain verification part 135 provides a message to the patient in at least one manner of a text message and voice for verifying pain, and the pain verification part 135 verifies pain by receiving the answer of the patient about the pain in at least one manner of a touch screen, a keyboard, and voice. When it is verified that the patient stopped executing the preset movement due to pain, the movement execution photographing part 133 may further photograph the patient executing the preset movement, after adding the pain frame identification information by the pain verification part 135.

Also, after the pain verification part 135 adds the pain frame identification information to the 1300th frame, the movement execution photographing part 133 further photographs the patient executing remaining preset movements such that the photographed movement information composed of total 2000 frames may be generated. The photographed movement information includes the pain frame identification information indicating that the 1300th frame is the pain frame.

In the meantime, when the pain verification part 135 verifies that the reason of stopping executing the preset movement is not pain, the movement execution photographing part 133 may continuously photograph the patient executing the preset movement without adding the pain frame identification information.

According to the present invention, the pain frame identification information may be added to the photographed movement information as described above. Accordingly, it is easy to identify the alignment position of the implant or the damaged part of the joint of the patient in performing examination.

The photographed movement information transmission part 136 transmits the photographed movement information generated by the movement execution photographing part 133 to the examination server 5. The photographed movement information may include the pain frame identification information added by the pain verification part 135, and may also include information obtained by photographing a particular static posture such as a standing posture. The photographed movement information transmitted by the photographed movement information transmission part 136 to the examination server is received and stored by the examination server 5. The photographed movement information analysis part 56 of the examination server 5 quantitatively analyzes the photographed movement information such that the photographed movement information may be utilized as information for examining the joint of the patient, medical research data, etc.

When the movement execution photographing part 133 photographs the patient executing the preset movement through infrared detection, the patient wears the infrared-reflective suit 3. The infrared-reflective suit 3 is not necessarily required. However, when the patient wears the infrared-reflective suit 3 and the movement execution photographing part 133 photographs the patient executing the preset movement through infrared detection, the body contour of the patient is clearly indicated in the photographed movement information. When using the infrared-reflective suit 3, it is possible to capture minute movements between 1˜10° in analyzing the photographed movement information.

It is desirable that the infrared-reflective suit 3 is coated with an infrared-reflective material on a surface thereof so as to obtain the photographed movement information that can efficiently distinguish the patient from the background. Specifically, a composite metal oxide such as a black pigment, i.e., Cr2O3-Fe2O3, a brown pigment, i.e., Fe2O3-Sb2O3-SiO2-Al2O3-TiO2, or materials of various infrared cut-off films may be used as the infrared-reflective material.

FIG. 8 is a view illustrating a detailed embodiment of the infrared-reflective suit 3. Referring to FIG. 8, the infrared-reflective suit 3 contains markings 31 for indicating landmarks of each body segment of the patient. The landmark of the body segment means a point that is an anatomical indicator of the body segment. In calculating the movement analysis information by the photographed movement information analysis part 56 of the examination server 5, points corresponding to landmarks for each body segment are used. The landmarks of each body segment are extracted by analyzing the photographed movement information. In this situation, in photographing the patient executing the preset movement, when the infrared-reflective suit 3 worn by the patient contains markings 31 indicating the landmarks of each body segment of the patient, it may be easy to extract the landmarks of the body segment of the patient from the photographed movement information.

In FIG. 8, the markings 31 are indicated at points corresponding to the medial epicondyle and lateral epicondyle that are the landmarks of the femur of the patient in a circular shape. This embodiment may be adapted to movement examination being performed when it is necessary to analyze the movement of the knee joint of the patient who has pain in the knee joint or has received a knee joint implant transplant. More markings 31 of the infrared-reflective suit 3 may be indicated as necessary, and the shape of the markings 31 may differ. Furthermore, the markings 31 may be indicated for different joints depending on symptoms, conditions, etc. of the patient.

In the meantime, it is desirable that the infrared-reflective suit 3 is generated in a form of being stuck to the patient body in order to obtain the photographed movement information that precisely describes the condition of the patient. The infrared-reflective suit 3 is generated in different sizes according to the gender, height, weight, etc. of the patient.

The examination server 5 analyzes the photographed movement information obtained by photographing the patient executing the preset movement, and generates information related to joint movement of the patient. The examination server 5 may be realized as a server connected to a plurality of patient terminals 1 via a wired/wireless communication network. In this way, the examination server 5 may serve as a management server managing the plurality of patient terminals 1 remotely distributed.

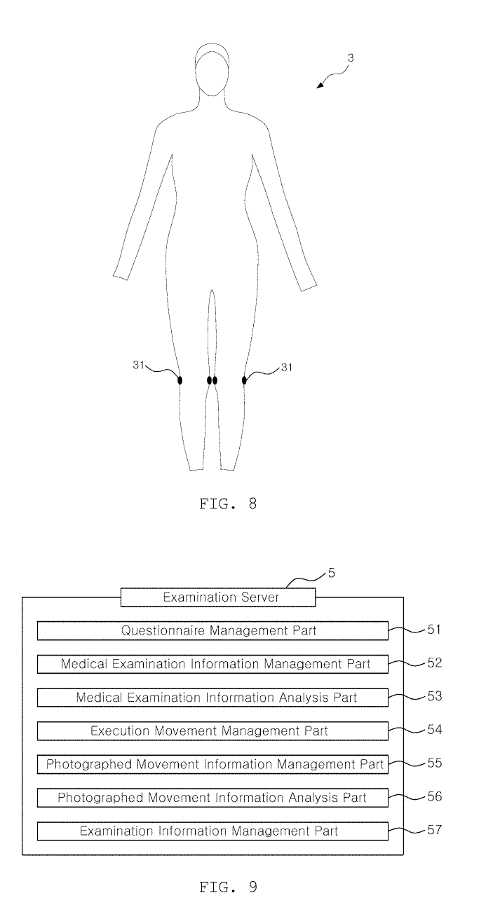

FIG. 9 is a configuration diagram illustrating the examination server of the joint examination system according to an embodiment of the present invention. Referring to FIG. 9, the examination server 5 may include a questionnaire management part 51, a medical examination information management part 52, a medical examination information analysis part 53, an execution movement management part 54, a photographed movement information management part 55, a photographed movement information analysis part 56, and an examination information management part 57.

The questionnaire management part 51 manages a questionnaire for the patient to perform self-examination. The questionnaire management part 51 identifies the patient by using the patient information transmitted by the patient terminal 1, and searches for a questionnaire corresponding to the identified patient to transmit the questionnaire to the patient terminal 1. As shown in FIG. 10, the questionnaire management part 51 may include a questionnaire DB 511, a questionnaire search transmission part 512, a preset questionnaire DB 513, and a questionnaire generation part 514.

The questionnaire DB 511 is a database storing a questionnaire related to examination of a patient. The questionnaire contains questions for the patient to perform self-examination, and the questions may be related to general health conditions and painful areas. In the present invention, self-examination by the patient may be performed through the patient terminal 1 by using the questionnaire stored in the questionnaire DB 511. As described above, the questionnaire may be provided in one preset form, but may be provided in different forms according to patients or symptoms. Since examination and treatment are performed for each individual patient, it is desirable that the questionnaire is prepared corresponding to each patient. Specifically, it is desirable that the questionnaire is generated based on at least one of the symptom of the patient, information on whether an implant transplant has been performed, content of an implant transplant, and rehabilitation status after an implant transplant. That is, it is desirable that the questionnaire DB 511 stores a patient-specific questionnaire. Here, the patient-specific questionnaire may be generated by the questionnaire generation part 514.

The questionnaire search transmission part 512 receives the patient information transmitted by the patient information transmission part 112 of the patient information transmission part 11 of the patient terminal 1, and searches the questionnaire DB 511 based on the patient information for the questionnaire to transmit the searched questionnaire to the patient terminal 1. The questionnaire reception part 121 of the patient terminal 1 receives the questionnaire, and the medical examination information generation part 122 provides the questionnaire to the patient to generate the medical examination information.

The questionnaire search transmission part 512 may search the questionnaire DB 511 for an appropriate questionnaire based on the patient information. For example, when the questionnaire DB 511 stores a patient-specific questionnaire, the questionnaire search transmission part 512 may search for a pre-generated questionnaire to be provided to a corresponding patient based on identification information included in the patient information. When the questionnaire DB 511 stores a symptom-specific questionnaire, the questionnaire search transmission part 512 may search for a pre-generated questionnaire for a patient having the corresponding symptom based on symptom information included in the patient information. For example, when a patient has received a knee joint implant transplant, the patient-specific questionnaire or symptom-specific questionnaire may have questions related to follow-up examination after the knee joint implant transplant.

The preset questionnaire DB 513 is a database storing at least one preset questionnaire used in generating the patient-specific questionnaire. The preset questionnaire may include at least one of a preset situation-specific questionnaire containing appropriate questions based on symptoms, progress, etc. and a preset surgery-specific questionnaire containing appropriate questions based on a type of a surgery. That is, the preset questionnaire may be provided as being differently set based on at least one of the patient medical record, the type of the surgery, and the purpose of the study.

Also, the preset questionnaire may include at least one option that can be added or deleted. Through this option, a patient-specific questionnaire can be generated by using one preset situation-specific questionnaire or one preset surgery-specific questionnaire. That is, while utilizing a particular preset questionnaire containing typical questions based on patient's situation or the type of the surgery, the patient-specific questionnaire optimized for each individual patient may be generated by adding or deleting an option to or from the particular preset questionnaire.

The questionnaire generation part 514 generates the questionnaire. The questionnaire generation part 514 may generate the questionnaire based on the preset questionnaire stored in the preset questionnaire DB 513. Specifically, the questionnaire generation part 514 provides an interface for generating a new patient-specific or symptom-specific questionnaire in order to perform a patient-specific or symptom-specific medical examination. The doctor accesses the examination server 5 by using a doctor terminal, and can generate a new questionnaire to be provided for self-examination of the patient through the interface provided by the questionnaire generation part 514.

The questionnaire generation part 514 may provide an interface for generating a patient-specific or symptom-specific customized questionnaire by selecting a preset questionnaire from the preset questionnaire DB 513, and adding or deleting an option to or from the preset questionnaire. The interface may be provided in a form of selecting other special options. Furthermore, it is desirable that the questionnaire generation part 514 provides an interface in a form of enabling the doctor to arbitrarily add a question to the questionnaire in addition to the option included in the preset questionnaire. Also, it is desirable that the questionnaire generation part 514 provides an interface in a form of generating a questionnaire containing a question requiring a descriptive answer in addition to a question providing choice.

According to the present invention, the doctor accesses the examination server 5 by using the doctor terminal, and can generate a patient-specific questionnaire by selecting a particular preset questionnaire from the preset questionnaire DB 513, by adding or deleting an option to or from the preset questionnaire, and by adding an arbitrary question through the interface provided by the questionnaire generation part 514.

The medical examination information management part 52 receives the medical examination information from the patient terminal 1 to store the medical examination information. As described above, the medical examination information means information containing answers of the patient to the questions of the questionnaire. As shown in FIG. 11, the medical examination information management part 52 may include a medical examination information reception storage part 521 and a medical examination information DB 522.

The medical examination information reception storage part 521 receives the medical examination information from the patient terminal 1 to store the medical examination information in the medical examination information DB 522. The medical examination information transmission part 123 of the medical examination execution part 12 of the patient terminal 1 transmits the medical examination information containing the answers of the patient to the questionnaire, to the examination server 5. The medical examination information reception storage part 521 receives the medical examination information to store the medical examination information in the medical examination information DB 522.

The medical examination information DB 522 is a database storing the medical examination information. The medical examination information stored in the medical examination information DB 522 may be utilized as fundamental data for examination of the patient, determination of a treatment progress, etc. Accordingly, it is desirable that the medical examination information stored in the medical examination information DB 522 is accumulatively stored and managed for each patient. For example, when the patient has received an implant transplant, it is desirable that pre-surgery medical examination information, post-surgery medical examination information, and follow-up medical examination information are accumulatively stored and managed.

In the meantime, as described above in the present invention, when the questionnaire is generated based on the preset questionnaire, it is easy to statistically analyze the medical examination information containing the answers to the questionnaire. Specifically, in spite of the patient-specific questionnaires, since the patient-specific questionnaire is generated by applying an option to a preset questionnaire, the number of cases that can be set for each preset questionnaire may have a limit. When the medical examination information is organized according to all classifications that can be set in that way, it is easy to perform a statistical analysis. Therefore, the medical examination information stored in the medical examination information DB 522 has high utilization and value as medical research data.

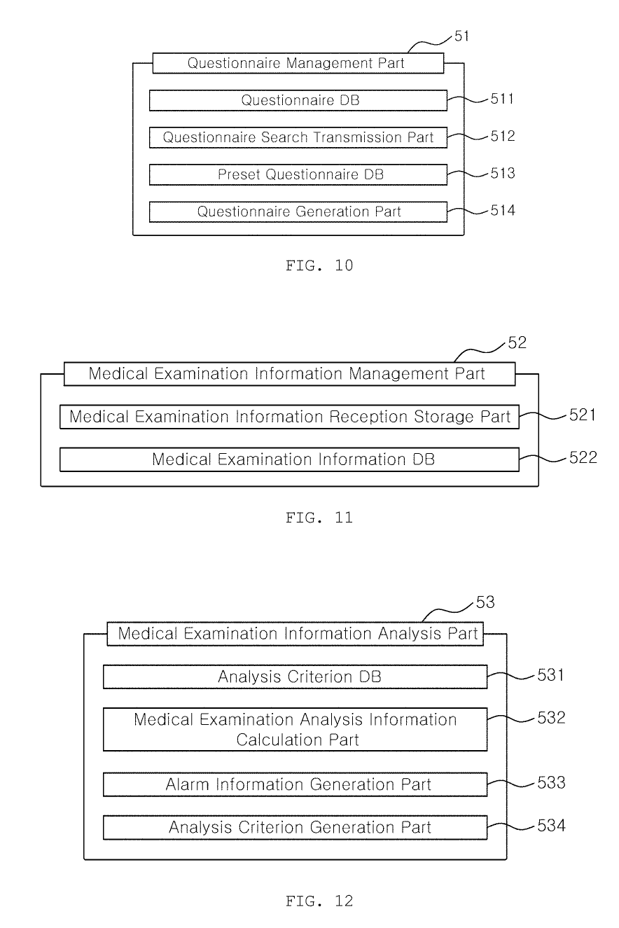

The medical examination information analysis part 53 analyzes the medical examination information. Referring to FIG. 12, the medical examination information analysis part 53 may include an analysis criterion DB 531, a medical examination analysis information calculation part 532, an alarm information generation part 533, and an analysis criterion generation part 534.

The analysis criterion DB 531 is a database storing an analysis criterion for comparatively analyzing an answer included in the medical examination information to a particular question. The analysis criterion may differ depending on a patient or a symptom, and the analysis criterion DB 531 may store a patient-specific or symptom-specific analysis criterion. However, as described above, since examination and treatment are performed for each individual patient, it is desirable that the analysis criterion is generated for each patient. The analysis criterion may be generated as a particular numerical value or range that is set for each patient for various indicators, i.e., a pain level of the joint, a blood glucose level, a blood pressure, etc.

The medical examination analysis information calculation part 532 calculates medical examination analysis information containing a quantified or classified emergency level by comparatively analyzing the answer included in the medical examination information to the particular question with regard to the analysis criterion. For example, when a patient who has received a joint implant transplant has diabetes, a patient-specific questionnaire being provided to the patient may contain a question related to a blood glucose level, and an analysis criterion may be a particular blood glucose level. In this case, the medical examination analysis information calculation part 532 comparatively analyzes the blood glucose level of the medical examination information with the analysis criterion, namely, a particular blood glucose level. When the blood glucose level is higher than the analysis criterion, the blood glucose level is classified as ‘emergency’, and when the blood glucose level is lower than the analysis criterion, the blood glucose level is classified as ‘normal’, thereby calculating the medical examination analysis information.

The alarm information generation part 533 generates alarm information when the quantified or classified emergency level contained in the medical examination analysis information is in a preset range. That is, the alarm information generation part 533 generates the alarm information informing that the doctor should urgently treat the patient, based on the medical examination analysis information. For example, when the emergency level included in the medical examination analysis information generated by the medical examination analysis information calculation part 532 is classified as ‘emergency’, the alarm information generation part 533 may generate the alarm information for warning. When the alarm information generation part 533 generates the alarm information, it is desirable that the examination information of the patient is immediately transmitted to the doctor terminal of the doctor who treats the patient.

The analysis criterion generation part 534 generates or modifies the analysis criterion. The analysis criterion generation part 534 provides an interface for generating a patient-specific or symptom-specific analysis criterion. The doctor accesses the examination server 5 by using the doctor terminal, and can generate the analysis criterion to be used in generating the medical examination analysis information through an interface provided by the analysis criterion generation part 534. For example, when a patient who has received a joint implant transplant has diabetes, a doctor who treats the patient can generate the analysis criterion based on a particular blood glucose level for the patient through the analysis criterion generation part 534, and can modify the analysis criterion for the patient depending on the situation.

The execution movement management part 54 receives a request of providing execution movement information that is information indicating a preset movement to be executed by a patient during movement examination from the patient terminal 1, searches for the execution movement information in response thereto, and transmits the execution movement information to the patient terminal 1. As shown in FIG. 13, the execution movement management part 54 may include an execution movement DB 541, an execution movement search transmission part 542, a preset execution movement DB 543, and an execution movement generation part 544.

The execution movement DB 541 is a database storing the execution movement information that is information indicating a preset movement to be executed by a patient during movement examination. Since it is common that a movement to be executed during movement examination differs depending on a symptom or condition of the patient, the execution movement DB 541 may store information indicating patient-specific or symptom-specific movements to be performed during movement examination as execution movement information. Since examination and treatment are performed for each individual patient, it is desirable to generate patient-specific execution movement information. For example, for the patient having pain in the knee joint, information indicating a lunge movement or squat movement may be stored as the execution movement information, and for the patient having pain in the shoulder joint, information indicating an arm twisting movement may be stored as the execution movement information.

The execution movement information is generated for each individual patient, and particularly, it is desirable to generate the execution movement information in advance based on at least one of the symptom of the patient, information on whether an implant transplant is performed, content of an implant transplant, and rehabilitation status after an implant transplant. The execution movement generation part 544 generates the execution movement information in advance. In the meantime, it is desirable that the execution movement information stored in the execution movement DB 541 includes visual information that visually shows a preset movement as well as voice information containing guiding voice for precisely executing the execution movement information.

The execution movement search transmission part 542 receives the patient information transmitted by the patient information transmission part 112 of the patient information transmission part 11 of the patient terminal 1, and searches the execution movement DB 541 based on the patient information for the execution movement information so as to transmit the execution movement information to the patient terminal 1. That is, the execution movement search transmission part 542 may search for the execution movement information corresponding to the patient based on the patient information, and may transmit the execution movement information to the patient terminal 1. The execution movement information transmitted to the patient terminal 1 may be received by the execution movement reception part 131, and may be provided to the patient by the movement execution request part 132.

The preset execution movement DB 543 is a database storing at least one piece of preset execution movement information used in generating the execution movement information. The preset execution movement information may include at least one piece of preset situation-specific execution movement information indicating appropriate movements based on symptoms, progress, etc. and preset surgery-specific execution movement information indicating appropriate movements based on a type of surgery. The preset execution movement information may include at least one option that can be added or deleted, and based on this, patient-specific execution movement information can be generated by using one piece of preset situation-specific execution movement information or one piece of preset surgery-specific execution movement information. That is, while utilizing particular preset execution movement information indicating a typical preset movement, the patient-specific execution movement information optimized for each individual patient may be generated by adding or deleting an option to or from the particular preset execution movement information depending on symptoms of the patient, the type of the surgery.

The execution movement generation part 544 generates the execution movement information. The execution movement generation part 544 may generate the execution movement information based on the preset execution movement information stored in the preset execution movement DB 543. Specifically, the execution movement generation part 544 provides an interface for generating new execution movement information to execute a patient-specific or symptom-specific medical examination. The doctor accesses the examination server 5 by using the doctor terminal, and can generate new execution movement information to be provided to execute a movement examination of the patient through the interface provided by the execution movement generation part 544.

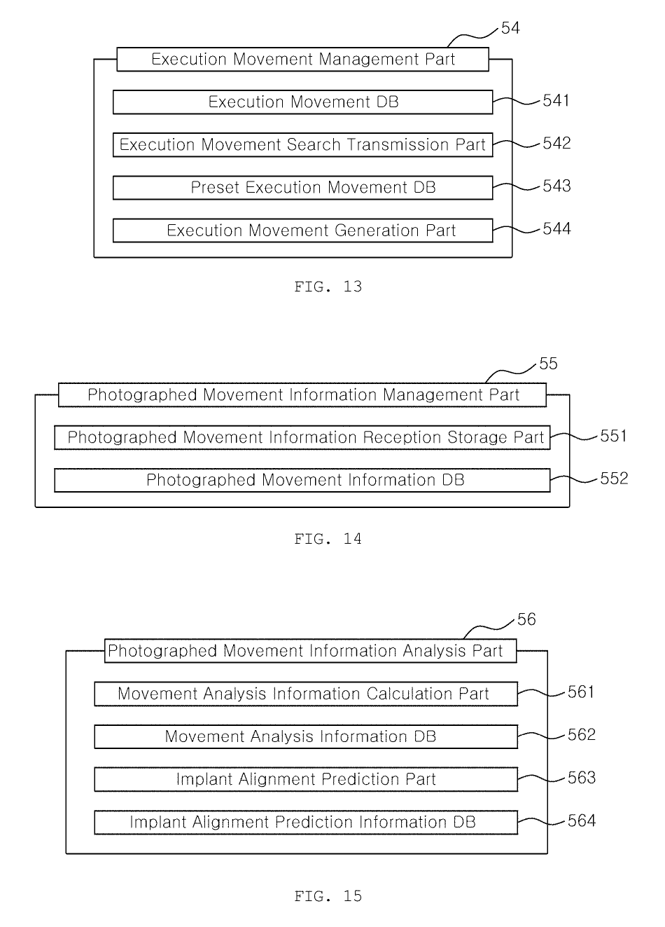

The photographed movement information management part 55 receives the photographed movement information from the patient terminal 1, and stores and manages the photographed movement information. As described above, the photographed movement information means information obtained by photographing the patient executing the preset movement indicated by the execution movement information during the movement examination, and may include information obtained by photographing the particular static posture. As shown in FIG. 14, the photographed movement information management part 55 may include a photographed movement information reception storage part 551 and a photographed movement information DB 552.

The photographed movement information reception storage part 551 receives the photographed movement information from the patient terminal 1 to store the photographed movement information in the photographed movement information DB 552. The photographed movement information transmission part 136 of the movement examination execution part 13 of the patient terminal 1 transmits the photographed movement information containing information obtained by photographing the patient executing the preset movement indicated by the execution movement information to the examination server 5. The photographed movement information reception storage part 551 receives the photographed movement information to store the photographed movement information in the photographed movement information DB 552.

The photographed movement information DB 552 is a database storing the photographed movement information. The photographed movement information stored in the photographed movement information DB 552 may be utilized as fundamental data for analyzing the movement of the joint related to the preset movement of the patient. Also, as described above, the photographed movement information may contain the pain frame identification information added by the pain verification part 135, as well as information obtained by photographing the particular static posture such as a standing posture. Also, it is desirable that the photographed movement information stored in the photographed movement information DB 552 is accumulatively stored and managed for each patient in terms of observing the progress for the patient, and obtaining research data. Specifically, in a case of a patient who has received an implant transplant, the photographed movement information may be distinguishably stored based on before surgery, after surgery, a follow-up period, etc. for each individual patient.

The photographed movement information analysis part 56 analyzes the photographed movement information obtained by photographing the patient executing the preset movement to generate information related to the movement of the joint of the patient. By analyzing the photographed movement information, the photographed movement information analysis part 56 may generate movement analysis information quantitatively indicating the movement of the joint related to the preset movement of the patient, implant alignment prediction information of the patient who has received an implant transplant, etc. As shown in FIG. 15, the photographed movement information analysis part 56 may include a movement analysis information calculation part 561, a movement analysis information DB 562, an implant alignment prediction part 563, and an implant alignment prediction information DB 564.

The movement analysis information calculation part 561 generates the movement analysis information quantitatively indicating the movement of the joint related to the preset movement of the patient by analyzing the photographed movement information. The movement analysis information may include a rotation between body segments of the patient that are adjacent to the joint related to the preset movement of the patient, and further include a translation between the body segments of the patient that are adjacent to the joint related to the preset movement of the patient. The rotation and translation of the body segments are physical quantities indicating a relative movement of a pair of body segments that are in contact with each other at a joint, and mean relative rotation and translation between segment coordinate systems of respective body segments in process of executing the preset movement. The segment coordinate system is a relative coordinate system where an end of the joint of each body segment is the origin and X-Y-Z axes are defined from the origin.

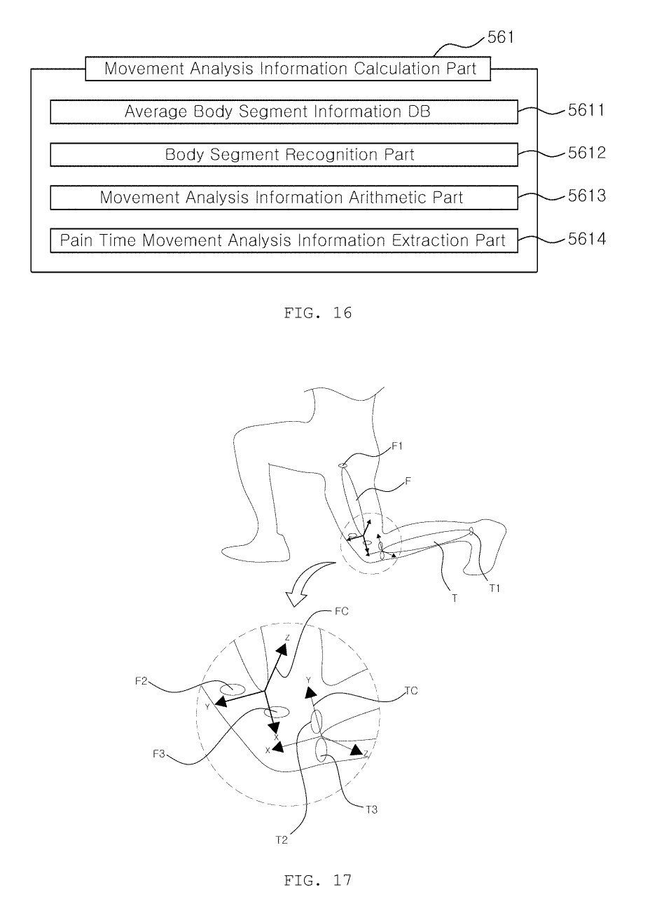

The movement analysis information calculation part 561 calculates the movement analysis information for quantitatively identifying the movement of the joint related to the preset movement of the patient such that joint management, i.e., examination, treatment, rehabilitation of the patient, is systematically performed. Referring to FIG. 16, the movement analysis information calculation part 561 may include an average body segment information DB 5611, a body segment recognition part 5612, a movement analysis information arithmetic part 5613, and a pain time movement analysis information extraction part 5614.

The average body segment information DB 5611 is a database storing information on an average length of a body segment in the human body. Specifically, the average body segment information DB 5611 may store information on an average length of a body segment of the human body for genders, ages, and races. The body segment means a part of a body that moves around a joint. For example, the femur and the tibia moving around a knee joint may be body segments. Data stored in the average body segment information DB 5611 may be utilized as fundamental data for recognizing the body segment of the patient.

The body segment recognition part 5612 recognizes the body segments adjacent to the joint related to the preset movement indicated in the photographed movement information. As shown in FIG. 17, when the execution movement information of the patient indicates a lunge movement, the body contour of the patient is identified for all frames of the photographed movement information, and based on the body contour, the lengths of the body segments, i.e., the femur (F) and tibia (T) are determined. Here, as described above, when the photographed movement information contains information obtained by photographing the particular static posture of the patient such as a standing posture, the length of the body segment identified in the static posture may be used as reference information. The length of the body segment indentified in the static standing posture and the length of the body segment calculated for each frame during execution of the preset movement are optimized through data stored in the average body segment information DB 5611, whereby the length of the body segment related to the movement of the joint can be defined.

In the meantime, in defining the length of the body segment through the optimization process, the body segment recognition part 5612 may apply coordinate constraints. For example, a part of six degrees of freedom (three rotations and three translations) that may relatively occur between two segment coordinate systems is constrained. In a case of a knee joint, since a longitudinal translation and a mediolateral translation rarely occur, a constraint of zero is assigned to the two translations to easily perform the optimization calculation.

The movement analysis information arithmetic part 5613 sets at least three landmarks for each of the recognized body segments, sets a segment coordinate system defining the movement of each body segment based on the landmarks of each body segment in every frame of the photographed movement information, and calculates the movement analysis information as a numerical value indicating the relative movement between body segments.

The movement analysis information arithmetic part 5613 derives a segment coordinate system of each body segment through recognition and tracking analysis on landmarks, namely, anatomical indicators of each of the recognized body segments. Since recognition and tracking analysis on landmarks of each body segment are performed to define a segment coordinate system of each body segment, at least three points should be recognized for each body segment and tracking analysis should be performed on the points. In FIG. 17, three landmarks (F1, F2, and F3) are recognized for the femur (F), and three landmarks (T1, T2, and T3) are recognized for the tibia (T). Next, by performing tracking analysis on movements of the landmarks during execution of the preset movement, namely, movements of the landmarks in every frame of the photographed movement information, a femur distal coordinate system (FC) and a tibia proximal coordinate system (TC) that are segment coordinate systems of the femur (F) and tibia (T) are derived.

In order to derive a segment coordinate system of each body segment through tracking analysis on landmarks of each body segment, at least three landmarks are required for each body segment in every frame of the photographed movement information. However, during execution of the preset movement, one or more body segments where at least three landmarks are not recognized (not shown on the frame) may shown on one frame of the photographed movement information due to a photographing angle. In this case, the movement analysis information arithmetic part 5613 applies interpolation based on frames before and after the frame where the landmark is not recognized such that a virtual landmark is inserted into the frame. Also, instead of the interpolation, after inserting a virtual redundancy marker around the landmark in every frame of the photographed movement information, tracking analysis is performed. When there is a frame where a particular landmark is not recognized, the redundancy marker around the particular landmark may be used instead of the particular landmark. Here, when using several redundancy markers, a high priority may be assigned to the redundancy marker near the bone.

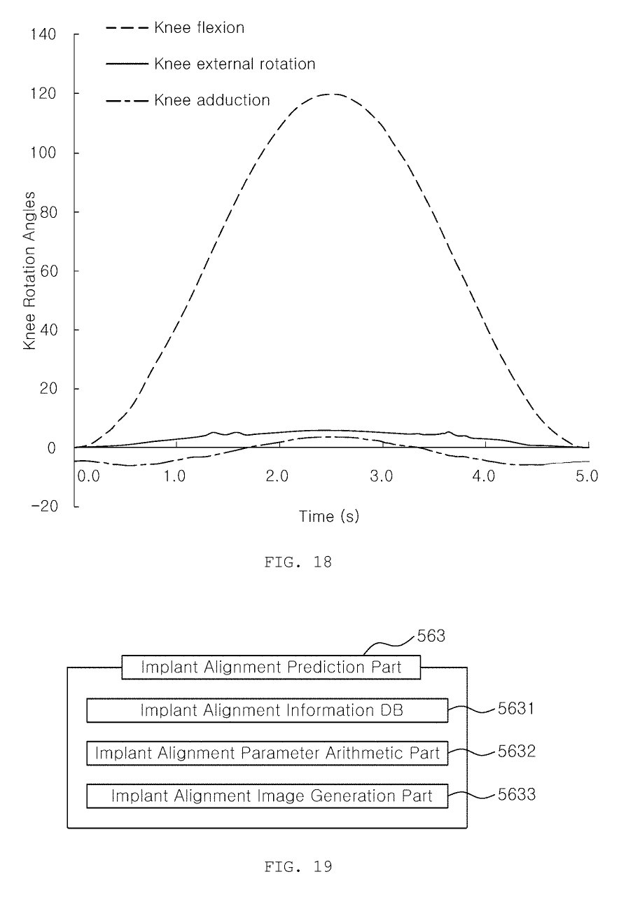

The movement analysis information arithmetic part 5613 calculates the movement analysis information by deriving at least one of a rotation and a translation between segment coordinate systems of body segments in every frame of the photographed movement information. FIG. 18 is a view illustrating a detailed embodiment of the movement analysis information calculated in FIG. 17. Referring to FIG. 18, the change in the rotation between segment coordinate systems of body segments, namely, a femur distal coordinate system (FC) and a tibia proximal coordinate system (TC) is illustrated over time in the photographed movement information. Specifically, FIG. 17 illustrates changes in three rotation angles between the femur distal coordinate system (FC) and the tibia proximal coordinate system (TC). There are a change in a rotation on a lateral axis of the patient body (knee flexion), a change in a rotation on a major axis of the patient body (knee external rotation), and a change in a rotation on an anteroposterior axis of the patient body (knee adduction).

In a case where the photographed movement information contains the pain frame identification information, the pain time movement analysis information extraction part 5614 extracts pain time movement analysis information that means the movement analysis information at the time when the patient feel pain while executing the preset movement based on the pain frame identification information and the movement analysis information. For example, the movement analysis information arithmetic part 5613 calculates the movement analysis information in a form as shown in FIG. 18, and when the photographed movement information contains pain frame identification information for 240 frames and the number of frames per second of the photographed movement information is 120, the pain time movement analysis information extraction part 5614 may extract a rotation value between segment coordinate systems as the pain time movement analysis information at a point corresponding to two seconds in FIG. 18.

The movement analysis information DB 562 is a database storing the movement analysis information that is calculated by the movement analysis information arithmetic part 5613. As described above, the movement analysis information is information quantitatively indicating the movement of the joint related to the preset movement of the patient. The movement analysis information may include a rotation between body segments of the patient that are adjacent to the joint related to the preset movement, and may further include a translation between the body segments of the patient that are adjacent to the joint related to the preset movement. Also, it is desirable that the movement analysis information DB 562 stores the pain time movement analysis information extracted by the pain time movement analysis information extraction part 5614.

The implant alignment prediction part 563 predicts an aligned state of an implant transplanted into the joint related to the preset movement, based on the movement analysis information. As shown in FIG. 19, the implant alignment prediction part 563 may include an implant alignment information DB 5631, an implant alignment parameter arithmetic part 5632, and an implant alignment image generation part 5633.

The implant alignment information DB 5631 is a database storing an implant alignment parameter that is a value indicating the alignment position of the implant transplanted into the joint of the patient, and several pieces of kinematic data quantitatively indicating the movement of the joint into which the implant is transplanted. That is, the implant alignment information DB 5631 is a database storing several pieces of kinematic data of an implant-transplanted patient having a particular implant alignment parameter, and enables the kinematic data of the implant-transplanted patients to be derived as a function of an implant alignment parameter.

The implant alignment parameter means a variable indicating the alignment position of the implant transplanted in to the joint of the patient. As an example of the implant alignment information of the knee joint implant-transplanted patient, for the tibia component, an inclination of the tibia component transplanted into the tibia proximal end, an AP position indicating where the center of the tibia component positions forward or backward relative to a mechanical axis, etc. may be used as the implant alignment parameter. For the femur component, an inclination (femoral flexion) of the femur component relative to the lateral axis perpendicular to the mechanical axis, an outwardly twisted degree (external rotation) of the femur component relative to the mechanical axis, etc. may be used as the implant alignment parameter.

In the meantime, the kinematic data means data measured when a patient moves the joint into which the implant with the implant alignment parameter is transplanted. The kinematic data may be identified as a function of the implant alignment parameter. Specifically, like the movement analysis information, the kinematic data may include a change in a rotation on a lateral axis of the patient body (knee flexion), a change in a rotation on a major axis of the patient body (knee external rotation), a change in a rotation on an anteroposterior axis of the patient body (knee adduction), anteroposterior translation (AP translation), etc.

In the meantime, the implant alignment information DB 5631 may further include photograph data used in generating the implant alignment image by the implant alignment image generation part 5633.

The implant alignment parameter arithmetic part 5632 derives the implant alignment parameter of the patient having the movement analysis information by comparatively analyzing the movement analysis information calculated by the movement analysis information arithmetic part 5613 and the kinematic data of the implant alignment information DB 5631.

FIGS. 20 to 22 are views illustrating a detailed embodiment of calculating the implant alignment parameter by the implant alignment parameter arithmetic part 5632. Referring to FIGS. 20 to 22, a process of deriving the implant alignment parameter by the implant alignment parameter arithmetic part 5632 will be described as follow.

FIG. 20 is a table of data extracted for particular points of the movement analysis information related to the movement of the knee joint of the patient. As shown in FIG. 18, the movement analysis information for one piece of photographed movement information contains a number of pieces of data for a continuous period of time. Among a number of pieces of data included in the movement analysis information, data in FIG. 20 is anteroposterior translations AP and rotations ER on the major axis of the patient body when rotations Flex on the lateral axis of the patient body are respectively 0°, 10°, 20°, 30°, and 40°. As described above, as a data for calculation, the implant alignment parameter arithmetic part 5632 may extract at least one of a rotation and a translation at a particular time or point from a number of pieces of data included in the movement analysis information as needed.

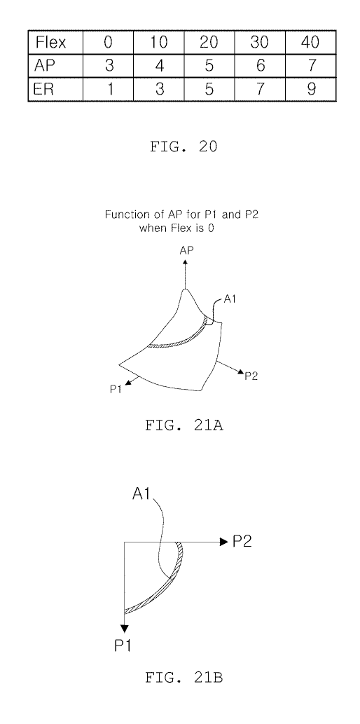

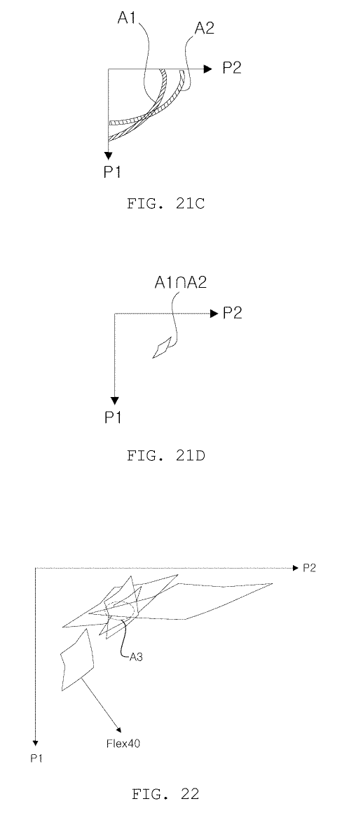

FIGS. 21A to 21D are views illustrating a process of deriving an implant alignment parameter by the implant alignment parameter arithmetic part 5632 based on the data extracted as shown in FIG. 20. Specifically, in FIGS. 21A to 21D, by using data extracted in FIG. 20, the implant alignment parameter arithmetic part 5632 derives, as a parameter of the tibia component of the knee joint implant among knee joint implant alignment parameters, the inclination (P1) of the tibia component transplanted into the tibia proximal end, and the AP position P2 indicating where the center of the tibia component positions forward or backward relative to the mechanical axis.

That is, as described above, kinematic data obtained when the patient who has received an implant transplant moves the transplanted joint implant may be identified based on a function of the implant alignment parameter of the patient. The implant alignment parameter arithmetic part 5632 identifies the provided data as the kinematic data, and derives the implant alignment parameter based thereon.

First, as shown in FIGS. 21A and 21B, when a rotation Flex on the lateral axis of the patient body is 0°, the implant alignment parameter arithmetic part 5632 derives an area A1 of coordinates of (P1, P2) where the anteroposterior translation AP is 3 based on a function of the anteroposterior translation AP. Here, FIG. 21B is a view illustrating the area A1 of coordinates of (P1, P2) in FIG. 21A on P1-P2 plane.

Next, as shown in FIG. 21C, when a rotation on the lateral axis of the patient body (knee flexion) is 0°, the implant alignment parameter arithmetic part 5632 derives an area A2 of coordinates of (P1, P2) where a rotation ER on the major axis of the patient body is 1 based on a function of the rotation ER on the major axis of the patient body. Here, the area A2 of coordinates of (P1, P2) in FIG. 21C is indicated on a P1-P2 plane by deriving the area A2 of coordinates of (P1, P2) where the rotation ER on the major axis of the patient body is 1, from the function of the rotation ER on the major axis of the patient body, indicated as values on an axis perpendicular to the P1 and P2 axes in FIG. 21A.

Furthermore, as shown in FIG. 21D, the implant alignment parameter arithmetic part 5632 derives an area (A1∩A2) where two areas A1 and A2 overlap. In this way, the implant alignment parameter arithmetic part 5632 derives possible combinations of the inclination P1 and AP position P2 that are implant alignment parameters of the tibia component of the knee joint implant based on the data where (Flex, AP, ER) is (0, 3, 1) in the table of FIG. 20.

As shown in FIG. 22, the implant alignment parameter arithmetic part 5632 repeatedly performs the process shown in FIGS. 21A to 21D for the remaining data in the table of FIG. 20, and through this, derives an area A3 that is an intersection of coordinates of (P1, P2). The implant alignment parameter arithmetic part 5632 may extract the center of mass of the area A3 that is the intersection of coordinates of (P1, P2) by using the final prediction inclination P1 and AP position P2 of the tibia component, and may further extract the final prediction inclination P1 and AP position P2 according to another reference.

In FIG. 22, there is no intersection when a rotation on the lateral axis of the patient body Flex is 40°, because the rotation Flex on the lateral axis of the patient body is large such that numerous error occur. Thus, the implant alignment parameter arithmetic part 5632 determines the data as an outlier, and does not consider the data for calculation.

In the same manner as the embodiment shown in FIGS. 20 to 22, the implant alignment parameter arithmetic part 5632 may derive implant alignment parameters based on the particular values contained in the movement analysis information. As described above, the implant alignment parameter arithmetic part 5632 derives the implant alignment parameters such that the implant alignment state of the implant-transplanted patient can be predicted, whereby the implant alignment state can be identified without X-ray photographing, MRI/CT photographing, etc.

In the meantime, the implant alignment parameter arithmetic part 5632 may utilize implant product information containing information on the manufacturer, the size, the surgery department of the implant transplanted into the patient. The implant product information may be contained in the patient information, or may be separately provided by medical staff. The implant alignment parameter arithmetic part 5632 calculates the implant alignment parameter by applying the product information of the implant transplanted into the patient, whereby more precise implant alignment prediction can be performed.

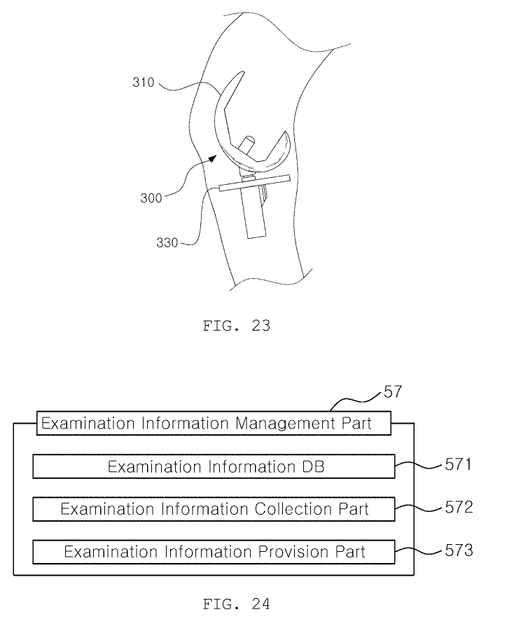

The implant alignment image generation part 5633 generates an implant alignment image, which is a prediction alignment image of the implant transplanted into the joint of the patient, based on the implant alignment parameter derived by the implant alignment parameter arithmetic part 5632. FIG. 23 is a view illustrating an embodiment of generating a knee joint implant alignment image by the implant alignment image generation part 5633. As described above, the implant alignment image generation part 5633 visually provides the alignment state of a knee joint implant 300 being predicted on a particular frame of the photographed movement information of the patient into which a knee joint implant 300 is transplanted, namely, a predicted implant alignment state of the implant-transplanted patient by combining the prediction positions of the femur component 310 and tibia component 330 without X-ray photographing, MRI/CT photographing, etc. Accordingly, the present invention can easily and effectively identify the progress after implantation in examining the patient who received an implant transplant.

Also, as described above, it is desirable that the implant alignment information DB 5631 stores photograph data used in generating the implant alignment image by the implant alignment image generation part 5633. In this case, the implant alignment image generation part 5633 may generate an implant alignment prediction photograph by using the photograph data.

In the meantime, the implant alignment image generation part 5633 may further utilize the implant product information containing information on the manufacturer, the size, the surgery department, etc. of the implant transplanted into the patient. The implant product information may be contained in the patient information, or may be separately provided by medical staff. The implant alignment image generation part 5633 generates the implant alignment image by applying the product information of the implant transplanted into the patient, whereby more precise implant alignment prediction can be performed.

The implant alignment prediction information DB 564 is a database storing the implant alignment parameter derived by the implant alignment parameter arithmetic part 5632 and the implant alignment image generated by the implant alignment image generation part 5633. That is, implant alignment prediction information means at least one of the implant alignment parameter derived by the implant alignment parameter arithmetic part 5632 and the implant alignment image generated by the implant alignment image generation part 5633. Through the implant alignment prediction information DB 564, the implant alignment prediction information is accumulatively and systematically managed, whereby the implant alignment prediction information can be usefully utilized in identifying pre-surgery, post-surgery, and the process of rehabilitation of the implant-transplanted patient.

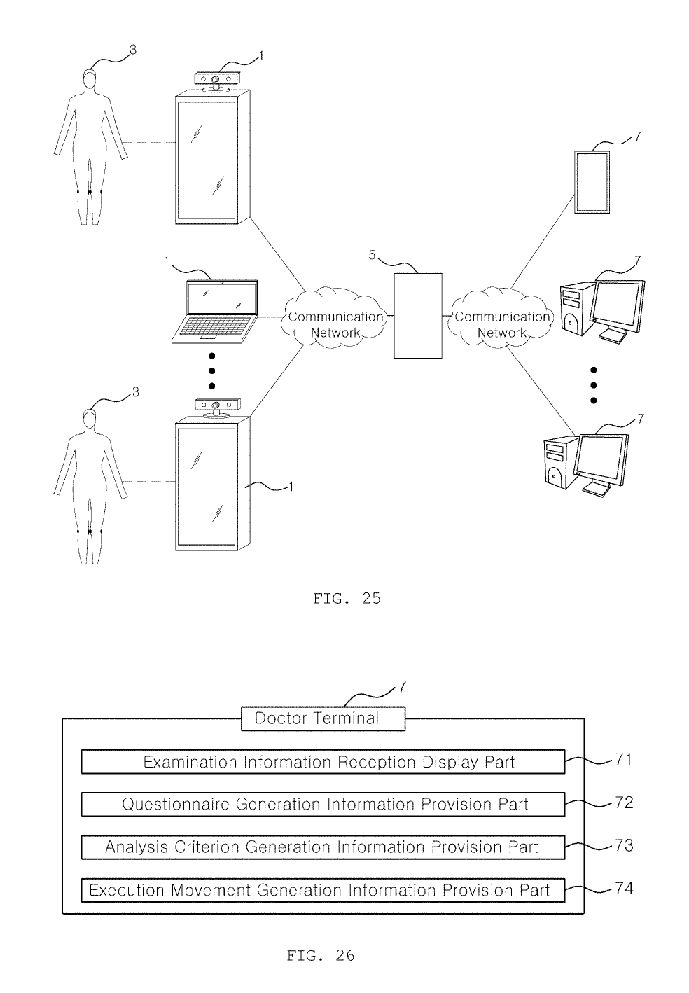

The examination information management part 57 collects, stores, and manages a patient-specific examination information containing at least one of the medical examination information, the medical examination analysis information, the alarm information, the photographed movement information, the movement analysis information, the pain time movement analysis information, the implant alignment parameter, and the implant alignment image. That is, the examination information is information managed for each patient, and contains at least one of the medical examination information, the medical examination analysis information, the alarm information, the photographed movement information, the movement analysis information, the pain time movement analysis information, the implant alignment parameter, and the implant alignment image. As shown in FIG. 24, the examination information management part 57 may include an examination information DB 571, an examination information collection part 572, and an examination information provision part 573.

The examination information DB 571 is a database storing the patient-specific examination information. In a case of an implant-transplanted patient, the examination information is divided into pre-surgery examination information, post-surgery examination information, and follow-up examination information. That is, the examination information DB 571 may accumulatively store and manage pre-surgery examination information, post-surgery examination information, and follow-up examination information for each patient.

Updating and managing of the examination information DB 571 may be performed by the examination information collection part 572, and the examination information DB 571 stores patient-specific examination information by being distinguished based on before surgery, after surgery, and follow-up period. By utilizing this, examination of the patient, management of joint movement, etc. can be systematically and continuously performed.

The examination information collection part 572 updates the examination information DB 571 when at least one of the medical examination information and the photographed movement information is newly received or when at least one of the medical examination analysis information, the alarm information, the movement analysis information, the pain time movement analysis information, the implant alignment parameter, and the implant alignment image is newly generated. Furthermore, the examination information collection part 572 may manage the examination information DB 571.

The examination information collection part 572 updates the examination information DB 571 when at least one of the medical examination information and the photographed movement information is newly received or when at least one of the medical examination analysis information, the alarm information, the movement analysis information, the pain time movement analysis information, the implant alignment parameter, and the implant alignment image is newly generated, thereby systematically and continuously manage the patient-specific examination information.

The examination information provision part 573 provides updated examination information to the doctor terminal when the examination information DB 571 has the updated examination information. That is, when at least one of medical examination information and photographed movement information for the patient is newly received or when at least one of medical examination analysis information, alarm information, movement analysis information, pain time movement analysis information, an implant alignment parameter, and an implant alignment image for the patient is newly generated, the examination information provision part 573 collects that to provide that to the doctor terminal of the medical institution where the patient is treated. The doctor who treats the patient can efficiently and precisely perform examination and treatment through examination information provided by the examination information provision part 573.

The examination information provision part 573 may provide updated examination information to the doctor terminal whenever the examination information DB 571 is updated or may provide periodically updated examination information at particular intervals. Also, the examination information provision part 573 may research the examination information DB 571 and may provide the researched examination information in response to the request of the doctor terminal.

In the meantime, when the updated examination information includes the alarm information, it is desirable that the examination information provision part 573 immediately provide the examination information to the doctor terminal. When the updated examination information includes the alarm information, it may be regarded as the patient is in an emergency and the patient needs immediate examination or treatment by the doctor.

FIG. 25 is a configuration diagram illustrating a joint examination system according to another embodiment of the present invention. Referring to FIG. 25, the joint examination system further includes a doctor terminal 7, compared to the embodiment of FIG. 3.

The doctor terminal 7 is a terminal installed in medical institution where a patient is treated, and receives examination information from the examination server 5 via a wired/wireless communication network. Specifically, the doctor terminal 7 receives examination information containing at least one of medical examination information, medical examination analysis information, alarm information, photographed movement information, movement analysis information, pain time movement analysis information, an implant alignment parameter, and an implant alignment image for the patient that are collected and transmitted by the examination information provision part 573 so as to utilize the examination information for joint examination, diagnosis, treatment, etc. of the patient. As shown in FIG. 26, the doctor terminal 7 may include an examination information reception display part 71, a questionnaire generation information provision part 72, an analysis criterion generation information provision part 73, and an execution movement generation information provision part 74.

The examination information reception display part 71 receives and displays the examination information. That is, the examination information reception display part 71 receives and displays the examination information being collected and transmitted by the examination information provision part 573. The examination information received by the examination information reception display part 71 is identified by the doctor and utilized as fundamental data for examining and treating the joint of the patient.

It is desirable that the examination information reception display part 71 preferentially displays the examination information including the alarm information, and displays other examination information in the descending order of the quantified or classified emergency level included in the medical examination analysis information. In this way, the doctor can preferentially identify examination information of the patient who needs urgent examination or treatment.

The questionnaire generation information provision part 72 provides information for generating a new questionnaire to the questionnaire generation part 514 of the questionnaire management part 51 of the examination server 5. As described above, the questionnaire generation part 514 provides an interface for generating a new questionnaire. The doctor terminal 7 accessed to the examination server 5 receives information related to generate a questionnaire through the questionnaire generation information provision part 72, and transmits the information to the questionnaire generation part 514, whereby the questionnaire generation part 514 can generate a new questionnaire. The questionnaire is generated before the patient performs self-examination through the patient terminal 1, thereby providing a patient-specific questionnaire.

The analysis criterion generation information provision part 73 provides analysis criterion generation information for generating or modifying the analysis criterion to the analysis criterion generation part 534 of the medical examination information analysis part 53 of the examination server 5. As described above, the analysis criterion generation part 534 provides an interface for generating a new analysis criterion or modifying an existing analysis criterion. The doctor terminal 7 accessed to the examination server 5 receives information related to generate the analysis criterion through the analysis criterion generation information provision part 73, and transmits the information to the analysis criterion generation part 534, whereby the analysis criterion generation part 534 can generate a new analysis criterion or modify the existing analysis criterion. The analysis criterion is generated before the patient performs self-examination through the patient terminal 1, thereby analyzing patient-specific medical examination information.

The execution movement generation information provision part provides information for generating new execution movement information to the execution movement generation part 544 of the execution movement management part 54 of the examination server 5. As described above, the execution movement generation part 544 provides an interface for generating new execution movement information. The doctor terminal 7 accessed to the examination server 5 receives information related to generate the execution movement information through the execution movement generation information provision part 74, and transmits the information to the execution movement generation part 544, whereby the execution movement generation part 544 can generate new execution movement information. The execution movement information is generated before the patient performs movement examination through the patient terminal 1, thereby providing patient-specific execution movement information.

In the meantime, as shown in FIG. 25, a plurality of doctor terminals 7 may be connected to the examination server 5. According to the present invention, examination information of several patients who are treated in several medical institutions can be effectively managed for each patient or for each medical institution through the examination server 5. Also, it is possible to easily collect big data that can be used in joint and implant research.

Although various embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A joint examination system comprising:
an examination server transmitting request information for performing examination of a joint of a patient to a patient terminal, receiving execution information from the patient terminal in response to the request information, and storing and analyzing the execution information.

2. The joint examination system of claim 1, wherein the request information includes a questionnaire containing a plurality of questions for performing self-examination on the joint of the patient, and
the execution information includes medical examination information containing answers of the patient to the plurality of questions contained in the questionnaire.

3. The joint examination system of claim 2, wherein the examination server includes a questionnaire management part managing a patient-specific questionnaire.

4. The joint examination system of claim 3, wherein the questionnaire management part includes:
a questionnaire DB storing the patient-specific questionnaire; and
a questionnaire search transmission part identifying the patient through patient information transmitted from the patient terminal, and searching the questionnaire DB for the patient-specific questionnaire of the identified patient to transmit the searched patient-specific questionnaire to the patient terminal.

5. The joint examination system of claim 4, wherein the questionnaire management part further includes:
a preset questionnaire DB storing at least one preset questionnaire for generating the patient-specific questionnaire; and
a questionnaire generation part generating the patient-specific questionnaire based on the preset questionnaire stored in the preset questionnaire DB.

6. The joint examination system of claim 5, wherein the preset questionnaire includes at least one option that can be added or deleted.

7. The joint examination system of claim 6, wherein the questionnaire generation part generates the patient-specific questionnaire by adding an arbitrary question to the preset questionnaire.

8. The joint examination system of claim 5, wherein the examination server further includes a medical examination information analysis part analyzing the medical examination information.

9. The joint examination system of claim 8, wherein the medical examination information analysis part includes:
an analysis criterion DB storing an analysis criterion for comparatively analyzing an answer included in the medical examination information to a particular question; and
a medical examination analysis information calculation part calculating medical examination analysis information containing a quantified or classified emergency level by comparatively analyzing the answer included in the medical examination information to the particular question with regard to the analysis criterion.

10. The joint examination system of claim 9, wherein the medical examination information analysis part further includes an alarm information generation part generating alarm information when the quantified or classified emergency level contained in the medical examination analysis information is in a preset range.

11. The joint examination system of claim 10, wherein the medical examination information analysis part further includes an analysis criterion generation part generating or modifying the analysis criterion.

12. The joint examination system of claim 11, wherein the request information includes execution movement information indicating a preset movement to be executed by the patient, and
the execution information includes photographed movement information obtained by photographing the patient executing the preset movement indicated by the execution movement information.

13. The joint examination system of claim 12, wherein the examination server includes an execution movement management part managing patient-specific execution movement information.

14. The joint examination system of claim 13, wherein the execution movement management part includes:
an execution movement DB storing the patient-specific execution movement information; and
an execution movement search transmission part identifying the patient through the patient information transmitted from the patient terminal, and searching the execution movement DB for patient-specific execution movement information of the identified patient to transmit the searched patient-specific execution movement information to the patient terminal.

15. The joint examination system of claim 13, wherein the examination server further includes a photographed movement information analysis part analyzing the photographed movement information.

16. The joint examination system of claim 15, wherein the photographed movement information analysis part includes a movement analysis information calculation part calculating movement analysis information quantitatively indicating a movement of the joint related to the preset movement of the patient by analyzing the photographed movement information.

17. The joint examination system of claim 16, wherein the movement analysis information includes a rotation between body segments of the patient that are adjacent to the joint related to the preset movement of the patient.

18. The joint examination system of claim 17, wherein the movement analysis information further includes a translation between the body segments of the patient that are adjacent to the joint related to the preset movement of the patient.

19. The joint examination system of claim 16, wherein the movement analysis information calculation part includes:
a body segment recognition part recognizing the body segments adjacent to the joint related to the preset movement of the patient indicated in the photographed movement information; and
a movement analysis information arithmetic part setting at least three landmarks for each of the recognized body segments, setting a segment coordinate system, which defines a movement of each of the recognized body segments, for each of frames of the photographed movement information based on the landmarks of each of the recognized body segments, and calculating the movement analysis information as a numerical value indicating a relative movement between the recognized body segments.

20. The joint examination system of claim 19, wherein the photographed movement information further includes pain frame identification information identifying a frame obtained at a time when the patient feels pain among the frames, and
the movement analysis information calculation part further includes a pain time movement analysis information extraction part extracting pain time movement analysis information that means the movement analysis information at the time when the patient feels pain while executing the preset movement based on the pain frame identification information and the movement analysis information.

21. The joint examination system of claim 20, wherein the photographed movement information analysis part further includes an implant alignment prediction part predicting an alignment state of an implant transplanted into the joint related to the preset movement of the patient based on the movement analysis information.

22. The joint examination system of claim 21, wherein the implant alignment prediction part includes:
an implant alignment information DB storing an implant alignment parameter indicating an alignment position of the implant transplanted into the joint of the patient and several pieces of kinematic data quantitatively indicating the movement of the joint into which the implant is transplanted; and
an implant alignment parameter arithmetic part deriving the implant alignment parameter of the patient by comparatively analyzing the movement analysis information calculated by the movement analysis information calculation part and the kinematic data of the implant alignment information DB.

23. The joint examination system of claim 22, wherein the implant alignment prediction part further includes an implant alignment image generation part generating an implant alignment image, which is a prediction alignment image of the implant transplanted into the joint of the patient, based on the implant alignment parameter derived by the implant alignment parameter arithmetic part.

24. The joint examination system of claim 23, wherein the examination server further includes an examination information management part managing patient-specific examination information containing at least one of the medical examination information, the photographed movement information, the medical examination analysis information, the movement analysis information, the pain time movement analysis information, the implant alignment parameter, and the implant alignment image.

25. The joint examination system of claim 24, wherein the examination information management part includes an examination information DB storing the patient-specific examination information.

26. The joint examination system of claim 25, wherein the examination information is divided into pre-surgery examination information, post-surgery examination information, and follow-up examination information in a case of an implant-transplanted patient.

27. The joint examination system of claim 25, wherein the examination information management part further includes an examination information collection part updating the examination information DB when at least one of the medical examination information and the photographed movement information is newly received or when at least one of the medical examination analysis information, the alarm information, the movement analysis information, the pain time movement analysis information, the implant alignment parameter, and the implant alignment image is newly generated.

28. The joint examination system of claim 27, wherein the examination information management part further includes an examination information provision part providing updated examination information to a doctor terminal when the examination information DB has the updated examination information.

29. The joint examination system of claim 28, wherein the examination information provision part immediately provides the updated examination information to the doctor terminal when the updated examination information contains the alarm information.

30. The joint examination system of claim 24, further comprising:
the patient terminal transmitting the patient information containing patient identification information to the examination server, receiving the request information from the examination server, and generating the execution information in response to the request information to transmit the execution information to the examination server.

31. The joint examination system of claim 30, wherein the patient terminal includes a patient information transmission part receiving the patient information and transmitting the patient information to the examination server.

32. The joint examination system of claim 31, wherein the patient terminal further includes a medical examination execution part receiving the questionnaire to provide the questionnaire to the patient, and generating the medical examination information by receiving the answers to the questionnaire so as to transmit the medical examination information to the examination server.

33. The joint examination system of claim 32, wherein the patient terminal further includes a movement examination execution part receiving the execution movement information to provide the execution movement information to the patient, and generating the photographed movement information by photographing the patient executing the preset movement indicated by the execution movement information so as to transmit the photographed movement information to the examination server.

34. The joint examination system of claim 33, wherein the movement examination execution part includes:
a movement execution request part receiving the execution movement information and requesting the patient to execute the preset movement of the execution movement information; and
a movement execution photographing part generating the photographed movement information by photographing the patient executing the preset movement.

35. The joint examination system of claim 34, wherein the movement execution photographing part photographs the patient executing the preset movement through infrared detection.

36. The joint examination system of claim 35, further comprising:
an infrared-reflective suit that the patient wears when being photographed by the movement execution photographing part.

37. The joint examination system of claim 36, wherein the infrared-reflective suit is coated with an infrared-reflective material on a surface thereof.

38. The joint examination system of claim 37, wherein the infrared-reflective suit contains markings for indicating the landmarks of each of the recognized body segments of the patient.

39. The joint examination system of claim 34, wherein the movement examination execution part further includes:
a movement stop recognition part recognizing movement stop when the preset movement of the patient is stopped over a preset period of time while the movement execution photographing part photographs the patient executing the preset movement; and
a pain verification part adding the pain frame identification information identifying the frame obtained at the time when the patient feels pain, to the photographed movement information when the movement stop recognition part recognizes the movement stop and pain is verified by the patient.

40. The joint examination system of claim 29, further comprising:
the doctor terminal receiving the examination information from the examination server.

41. The joint examination system of claim 40, wherein the doctor terminal further includes an examination information reception display part receiving the examination information and displaying the examination information.

42. The joint examination system of claim 41, wherein the examination information reception display part preferentially displays the examination information containing the alarm information, and displays other examination information in a descending order of the quantified or classified emergency level included in the medical examination analysis information.

43. The joint examination system of claim 41, wherein the doctor terminal further includes a questionnaire generation information provision part providing questionnaire generation information for generating the questionnaire to the questionnaire generation part.

44. The joint examination system of claim 43, wherein the doctor terminal further includes an analysis criterion generation information provision part providing analysis criterion generation information for generating or modifying the analysis criterion to the analysis criterion generation part.
